(19) United States
(12) Patent Application Publication
(10) Pub. No.: US 2016/0318104 A1
(43) Pub. Date: Nov. 3, 2016

(54) GRADIENT SINTERED METAL PREFORM

(71) Applicant: UNITED TECHNOLOGIES CORPORATION, Farmington, CT (US)

(72) Inventors: Joe Ott, Enfield, CT (US); Wendell V. Twelves, JR., Glastonbury, CT (US); Sergey Mironets, Charlotte, NC (US); Lexia Kironn, Rocky Hill, CT (US); Evan Butcher, Manchester, CT (US); Gary A. Schirtzinger, Glastonbury, CT (US)

(21) Appl. No.: 15/103,981

(22) PCT Filed: Dec. 5, 2014
(86) PCT No.: PCT/US2014/068852

§ 371 Date: Jun. 13, 2016

Related U.S. Application Data
(60) Provisional application No. 61/919,126, filed on Dec. 20, 2013.

(51) Int. Cl. B22F 7/02; B21J 5/02; B33Y 10/00; B33Y 80/00; B22F 3/105; B22F 5/00

(52) U.S. Cl. CPC B22F 7/02; B22F 3/1055; B22F 5/009; B33Y 10/00; B33Y 80/00; B21J 5/02; B22F 2003/1057; B33Y 50/02

(57) ABSTRACT

A method of forming a metal component with two and three dimensional internal functionally graded alloy composition gradients includes forming the component by a powder based layer-by-layer additive manufacturing process. The areal composition distribution of each powder layer is determined by simultaneously depositing different powders and powder mixtures through a mixing valve attached to a single nozzle during powder deposition. The layers are then sintered with a directed energy source to form a forging preform. The preform is then forged to form a component.

### BACKGROUND

This invention relates generally to the field of additive manufacturing. In particular, the invention relates to an additive manufacturing process that produces metal components with two and three dimensional internal functionally graded alloy composition gradients.

Additive manufacturing is a process by which parts can be made in a layer-by-layer fashion by machines that create each layer according to an exact three-dimensional (3-D) computer model of a part. In powder bed additive manufacturing, a layer of powder is spread on a platform and selective areas are joined by sintering or melting by a directed energy beam. The platform is indexed down, another layer of powder is applied, and selected areas are again joined. The process is repeated thousands of times until a finished 3-D part is produced. In direct deposit additive manufacturing technology, small amounts of molten or semi-solid material are applied to a platform according to a 3-D model of a part by extrusion, injection or wire feed and energized by an energy beam to bond the material to form a part. Common additive manufacturing processes include selective laser sintering, direct laser melting, direct metal deposition and electron beam melting.

Once the component is manufactured, the component is incorporated into a system to be used for a specific function. An example is a gas turbine engine. During operation, different regions of a component may be exposed to different thermal and mechanical environments that stress the component. Some regions may require high temperature creep resistance while other regions may experience high contact loading that require high cycle fatigue strength.

### SUMMARY

A method of forming a metal component with two and three dimensional internal functionally graded alloy composition gradients includes forming the component by a powder based layer-by-layer additive manufacturing process. The areal composition distribution of each powder layer is determined by simultaneously depositing different powders and powder mixtures through a mixing valve attached to a single nozzle during powder deposition. The layers are then sintered with a directed energy source to form a forging preform. The preform is then forged to form a component.

In an embodiment, a cylindrical metal component includes an outer rim of a first alloy, an inner hub section of a second alloy, and at least one functionally graded alloy transition region of the first alloy and the second alloy between the outer rim and the inner hub section.

### BRIEF DESCRIPTION OF THE DRAWINGS

FIG. 1 is a schematic representation of an additive manufacturing process of the invention.

FIG. 2 is a schematic representation of a powder distribution system of the invention.

### DETAILED DESCRIPTION

The invention relates to a metal component with internal two and three dimensional functionally graded composition gradients tailored to resist different thermal and mechanical stresses in different regions of the component during service.

Components containing predetermined internal compositional, thermal, and mechanical property variations throughout the body of the component may be formed using additive manufacturing. Additive manufacturing is a process wherein three-dimensional (3-D) objects are produced with a layer-by-layer technique directly from a digital model. The additive manufacturing process is in distinct contrast to conventional subtractive methods of manufacturing wherein metal is removed in a piece-by-piece fashion from a part by machining, grinding, etc. or by other forming methods such as forging, casting, injection molding, etc.

In additive manufacturing, a piece is formed by the deposition of successive layers of material with each layer adhering to the previous layer until the build is completed. A single layer may be formed by sintering, fusing or otherwise densifying specific layers of a powder bed by a computer controlled beam of energy or by depositing liquid or semi liquid drops on specific areas of a work piece by a computer controlled deposition apparatus. Common energy sources are laser and electron beams. With the present invention, each layer may be formed of multiple powder materials distributed over one or more gradients.

Powder based additive manufacturing processes applicable to the present invention include laser additive manufacturing (LAM), selective laser sintering (SLS), selective laser melting (SLM), direct laser melting (DLM), electron beam melting (EBM), direct metal deposition and others known in the art.

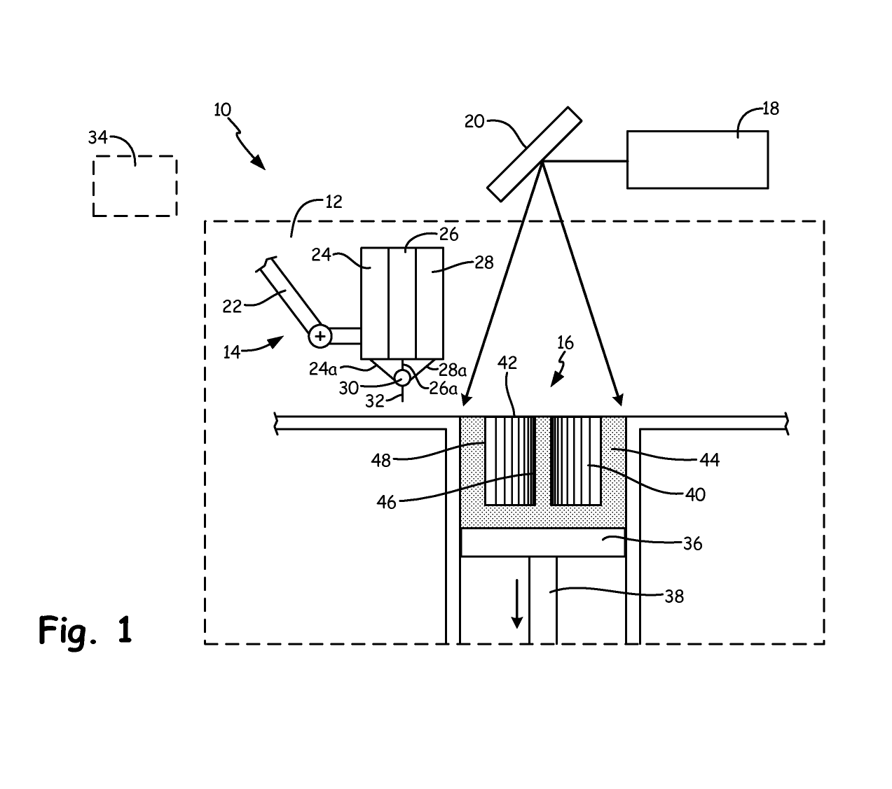

An example of a powder based additive manufacturing process of the invention is shown in FIG. 1. Process 10 includes manufacturing chamber 12 containing devices that produce solid components by additive manufacturing. An example of process 10 is selective laser sintering (SLS). SLS process 10 comprises powder deposition system 14, build chamber 16, laser 18, and scanning minor 20. Powder deposition system 14 includes robotic support 22, powder hoppers 24, 26, and 28, delivery tubing 24a, 26a, 28a, mixing valve 30, powder dispensing nozzle 32 and robotic control system 34.

Build chamber 16 comprises platform 36 on moveable piston 38.

During operation of SLS process 10, under direction from control system 34, powder deposition system 14 traverses over platform 36 dispensing an areal array of powder compositions according to a 3-D computer model of component 40 stored in memory in control system 34. After a layer of powder is deposited on platform 36, powder deposition system 14 retracts to a starting position. Laser 18 and scanning minor 20 are then activated via control system 34 to direct a laser beam over build platform 36 to sinter selected areas of powder to form a single sintered layer 42 of component 40 on build platform 36. After the build, unsintered powder 44 remains packed around component 40.

In the next step, piston 38 indexes platform 36 down by one layer of thickness. Powder deposition system 14 traverses over build chamber 16 dispensing another array of powder compositions according to a 3-D computer model of component 40 stored in a memory in control system 34. After the layer is deposited, powder deposition system 14 retracts to a starting position. Laser 18 and scanning minor 20 are activated to direct a laser beam over the deposited layer to sinter selected areas of powder to form the next sintered layer 42 of component 40 on build platform 36 and to attach the sintered layer to the previously sintered underlying layer. The process is repeated until solid component 40 is completed.

Powder deposition system 14 is shown in FIG. 1 as containing three powder hoppers 24, 26, and 28 containing three kinds of powder. It should be noted here that there is no limit on the number of different kinds of powder that can be deposited by deposition system 14 of the invention.

Powder deposition system 14 is just one embodiment of the invention. By simultaneously depositing predetermined mixtures of two or more different powders over selected areas of build platform 36 in a layer-by-layer fashion, two and three dimensional internal functionally graded composition gradients can be formed in a finished component. In an embodiment of the present invention, the component may be a sintered forging preform.

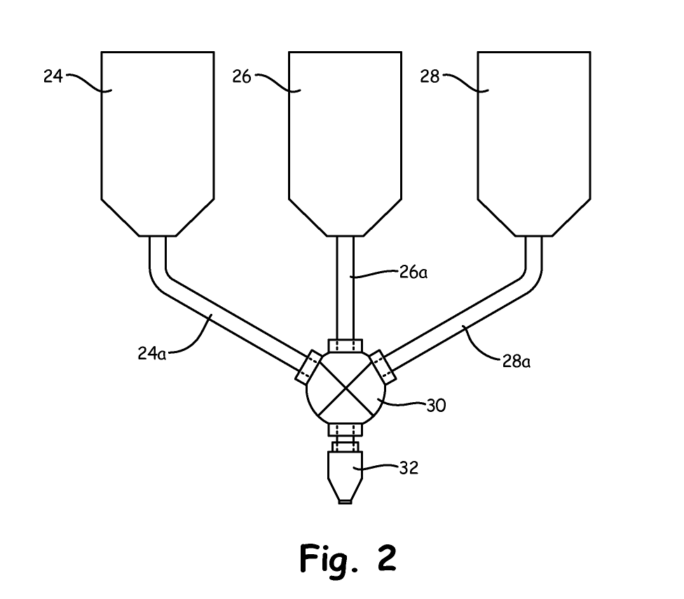

Operative features of powder deposition system 14 are mixing valve 30 and deposition nozzle 32 as shown in more detail in FIG. 2. Mixing valve 30 is connected to hoppers 24, 26, and 28 by tubes 24a, 26a, and 28a. Mixing valve 30 is capable of supplying deposition nozzle 32 with any mixture of powders in any concentration depending on system requirements. In addition, control of mixing valve 30 can be manual or automatic (such as via control system 34) depending on system requirements. In particular, mixing valve 30 can be actively controlled by control system 34 to vary the powder gradient according to a predetermined plan stored in control system 34. Deposition nozzle 32 may be any powder deposition nozzle known in the art such as a single orifice nozzle.

In an embodiment, components formed by the additive manufacturing process of the invention may be sintered forging preforms. The density of the preform may be from about 75 percent to about 85 percent.

Component 40, as schematically shown in cross-section in FIG. 1, may be a cylindrical sintered forging preform surrounded by unsintered powder 44. The density of vertical lines in component 40, schematically illustrate a functionally graded radial composition gradient from internal core wall 46 to external diameter wall 48. Component 40 may be rotor disk for a gas turbine engine with a gradient between a hub and a rim.

The process of this invention can be used to form components of metal, ceramic, polymer, or composite materials. In an embodiment, metals are selected for aerospace applications, such as gas turbine engine applications. Metal alloys of interest in the present invention, are nickel base, iron base, cobalt base superalloys and mixtures thereof.

### Discussion of Possible Embodiments

The following are non-exclusive descriptions of possible embodiments of the present invention.

A method of forming a metal component with two and three dimensional internal alloy compositional gradients includes: forming the component by powder base layer-by-layer additive manufacturing process; controlling the areal composition of each powder layer by depositing different powders to different areas through a single powder deposition nozzle during powder deposition; and sintering the layer with a directed energy source to form the component.

The method of the preceding paragraph can optionally include additionally and/or alternatively any, one or more of the following features, configurations and/or additional components:

The directed energy source may be a laser.

The powder deposition nozzle may be positioned by a computer controlled robotic support.

The different powders may be selected with the use of a mixing valve attached to two or more powder sources.

The mixing valve may be controlled by manual or electronic means.

The two dimensional composition gradients may be radial composition gradients.

The metal may be a nickel based, iron based, cobalt based superalloy or mixtures thereof.

The component may be a forging preform.

The forging preform density may be about 75 percent to about 85 percent.

The forging preform may be forged into a turbine disk.

A cylindrical metal component may include: an outer rim section of at least a first alloy; an inner hub section of at least a second alloy; and at least one functionally graded alloy transition region between the outer rim section and the inner hub section.

The metal component of the preceding paragraph can optionally include additionally and/or alternatively, one or more of the following features, configurations and/or additional components:

The component may be a sintered forging preform.

The component may be formed by a powder based layer-by-layer additive manufacturing process wherein the radial composition of each layer is formed by depositing at least two powders through a single nozzle during formation of each layer.

The different powders may be selected with the use of a mixing valve attached to two or more powder sources.

The control of the mixing valve may be by manual or electronic means.

The powder deposition nozzle may be positioned by a computer controlled robotic support.

Each layer may be sintered by a laser.

The sintered component density may be about 75 percent to about 85 percent.

The metal may be a nickel based, iron based, cobalt based superalloy or mixtures thereof.

The component may be a turbine component.

Although the present invention has been described with reference to preferred embodiments, workers skilled in the art will recognize that changes may be made in form and detail without departing from the spirit and scope of the invention.

1. A method of forming a metal component with two and three dimensional internal alloy compositional gradients comprises:
forming the component by a powder-based layer-by-layer additive manufacturing process;
controlling the areal composition of each powder layer by depositing different powders to different areas through a single powder deposition nozzle during powder deposition; and
sintering the layer with a directed energy source to form the component.

2. The method of claim 1 wherein the directed energy source is a laser.

3. The method of claim 1 wherein the powder deposition nozzle is positioned by a computer controlled robotic support.

4. The method of claim 1 wherein the different powders are selected with the use of a mixing valve attached to two or more powder sources.

5. The method of claim 4 wherein the mixing valve may be controlled by manual or electronic means.

6. The method of claim 1 wherein the two-dimensional composition gradients are radial composition gradients.

7. The method of claim 1 wherein the metal is a nickel based, iron based, cobalt based superalloy or mixtures thereof.

8. The method of claim 1 wherein the component is a forging preform.

9. The method of claim 1 wherein the forging preform density is about 75 percent to about 85 percent.

10. The method of claim 8 and further comprising forging the preform into a turbine disk.

11. A cylindrical metal component comprising:
an outer rim section of at least a first alloy;
an inner hub section of at least a second alloy; and
at least one functionally graded alloy transition region between the outer rim section and the inner hub section.

12. The component of claim 11 wherein the component is a sintered forging preform.

13. The component of claim 11 wherein the component is formed by a powder based layer-by-layer additive manufacturing process wherein the radial composition of each layer is formed by depositing at least two powders through a single nozzle during formation of each layer.

14. The component of claim 13 wherein the different powders are selected with the use of a mixing valve attached to two or more powder sources.

15. The component of claim 14 wherein control of the mixing valve may be by manual or electronic means.

16. The component of claim 13 wherein the powder deposition nozzle is positioned by a computer controlled robotic support.

17. The component of claim 13 wherein each layer is sintered by a laser.

18. The component of claim 12 wherein the sintered component density is about 75 percent to about 85 percent.

19. The component of claim 11 wherein the metal is a nickel based, iron based, cobalt based superalloy or mixtures thereof.

20. The component of claim 11 wherein the component is a turbine component.
